(19) United States
(12) Patent Application Publication
(10) Pub. No.: US 2026/0192501 A1
(43) Pub. Date: Jul. 9, 2026

(54) TRANSPARENT POLYPROPYLENE RESIN AND PREPARATION METHOD THEREOF

(71) Applicants: ZHEJIANG CHAMBROAD POLYOLEFIN PERFORMANCE MATERIALS CO., LTD., Hangzhou (CN); SHANDONG CHAMBROAD POLYOLEFIN PERFORMANCE MATERIALS CO., LTD., Binzhou (CN)

(72) Inventors: Bo LUAN, Binzhou (CN); Wenbo YUAN, Hangzhou (CN); Weiping ZHENG, Binzhou (CN); Dewen LI, Hangzhou (CN); Haiyan LI, Binzhou (CN)

(73) Assignees: ZHEJIANG CHAMBROAD POLYOLEFIN PERFORMANCE MATERIALS CO., LTD., Hangzhou (CN); SHANDONG CHAMBROAD POLYOLEFIN PERFORMANCE MATERIALS CO., LTD., Binzhou (CN)

(21) Appl. No.: 19/441,841

(22) Filed: Jan. 6, 2026

(30) Foreign Application Priority Data
Jan. 6, 2025 (CN) 202510018212.0

(51) Int. Cl. B29C 48/00; B29K 23/00; C08F 4/642; C08F 4/654; C08F 210/06; C08F 297/08; C08K 5/1575

(52) U.S. Cl. CPC B29C 48/022; C08F 4/6426; C08F 4/6545; C08F 210/06; C08F 297/083; C08K 5/1575; B29C 2948/92209; B29K 2023/12; B29K 2995/0026

(57) ABSTRACT

The present disclosure provides a transparent polypropylene resin and a preparation method thereof. The method comprises steps of: A) pre-polymerizing propylene in the presence of a main catalyst, a polymeric nucleating agent, a co-catalyst, and an external electron donor; B) subjecting the pre-polymerization product, propylene, ethylene, and hydrogen to a polymerization reaction to obtain a polypropylene powder; C) continuing a polymerization reaction of the polypropylene powder, propylene, ethylene, and hydrogen to obtain a polypropylene resin powder; D) mixing the polypropylene resin powder, an antioxidant, a halogen scavenger, an antistatic agent, and a sorbitol-based nucleating agent evenly to obtain a mixture; and E) extruding the mixture through an extruder to obtain a transparent polypropylene material, wherein a temperature of the highest temperature zone of the extruder is 230° C. to 240° C. The present disclosure significantly reduces the production cost of transparent polypropylene and enhances the market competitiveness of the product.

### CROSS REFERENCE TO RELATED APPLICATIONS

This application claims the priority of Chinese Patent Application No. 202510018212.0, filed with the China National Intellectual Property Administration on Jan. 6, 2025, and titled with “TRANSPARENT POLYPROPYLENE RESIN AND PREPARATION METHOD THEREOF”, which is hereby incorporated by reference in its entirety.

### FIELD

The present disclosure relates to the technical field of polymer materials, and particularly relates to a transparent polypropylene resin and a preparation method thereof.

### BACKGROUND

Polypropylene is a semi-crystalline polymer. It is widely used due to its advantages such as low density, good optical and heat resistance properties, excellent chemical corrosion resistance and insulation strength, excellent water vapor barrier properties, and low odor, making it one of the three major general-purpose plastics. Random copolymer polypropylene has good transparency and toughness and can be used to produce transparent products. Existing transparent polypropylene plastics typically use random copolymer polypropylene as the base resin and add sorbitol-based transparent nucleating agents to improve the transparency of the product.

Currently, sorbitol-based transparent nucleating agents have developed to the fourth generation. The first-generation sorbitol-based nucleating agents have no substituents on the benzene ring, with a representative product being Millad 3905 ((1,3:2,4)-di(3,4-dimethyldibenzylidene) sorbitol, abbreviated DMDBS) from Milliken Company. This nucleating agent has low cost and average nucleating effect, and is unstable at high temperatures, and prone to decomposition releasing the parent aldehyde. The second-generation products are characterized by substituents such as chlorine and methyl at the para-position of the benzene ring, with a representative product being Millad 3940 ((1,3:2,4)-di(p-methyldibenzylidene) sorbitol, abbreviated MDBS) from Milliken Company. Its transparency-enhancing efficiency is greatly improved, but the odor remains significant. The third-generation Millad 3988 product shows significant improvements in transparency enhancement, nucleation performance, and odor reduction, and is currently the most widely used transparent nucleating agent. However, the haze of polypropylene materials prepared using the third-generation transparent nucleating agent is typically in the range of 8% to 10%, making it impossible to produce high-transparency polypropylene products with a haze of <6%.

The fourth-generation transparent nucleating agent is the Millad NX 8000, a benzyl derivative of sorbitol. The melt dispersion effect of the fourth-generation nucleating agent is significantly better than that of the third-generation nucleating agent. Therefore, the fourth-generation transparent nucleating agent NX 8000 can be used to prepare high-transparency polypropylene products, but it is expensive, increasing the preparation cost of transparent polypropylene. Furthermore, a common problem with transparent nucleating agents is that they can significantly improve the transparency of polypropylene at a certain addition amount, but after the effective content reaches a certain level, for example, when the addition amount of the third-generation and fourth-generation nucleating agents exceeds 3000 ppm, there is no significant further improvement in the transparency of the polypropylene resin; and they cannot simultaneously optimize mechanical properties.

### SUMMARY

An objective of the present disclosure is to provide a transparent polypropylene resin and a preparation method thereof. The transparent polypropylene resin of the present disclosure has low cost, significantly reduced haze, and improved rigidity, toughness, and heat resistance.

The present disclosure provides a method for preparing a transparent polypropylene resin, which comprises steps of:
A) pre-polymerizing propylene in the presence of a main catalyst, a polymeric nucleating agent, a co-catalyst, and an external electron donor;
wherein the polymeric nucleating agent is selected from the group consisting of poly(vinylcyclopentane), poly(vinylcyclohexane), poly(vinyl-2-methylcyclohexane), poly(3-methyl-1-butene), poly(3-ethyl-1-hexene), poly(3-methyl-1-pentene), polystyrene, and a combination thereof; and a mass ratio of the main catalyst to the polymeric nucleating agent is 1:(1-2);
B) subjecting the pre-polymerization product, propylene, ethylene, and hydrogen to a polymerization reaction to obtain a polypropylene powder;
C) continuing a polymerization reaction of the polypropylene powder, propylene, ethylene, and hydrogen to obtain a polypropylene resin powder;
D) mixing the polypropylene resin powder, an antioxidant, a halogen scavenger, an antistatic agent, and a sorbitol-based nucleating agent evenly to obtain a mixture;
wherein the sorbitol-based nucleating agent is selected from the group consisting of 1,3:2,4-dibenzylidene sorbitol, 1,3:2,4-di(4-methylbenzylidene) sorbitol, 1,3:2,4-di(4-ethylbenzylidene) sorbitol, 1,3:2,4-bis(3,4-dimethylbenzylidene) sorbitol, and a combination thereof; and a mass ratio of the polymeric nucleating agent to the sorbitol-based nucleating agent is 1:(75-150); and
E) extruding the mixture through an extruder to obtain a transparent polypropylene material;
wherein a temperature of the highest temperature zone of the extruder is 230° C. to 240° C.

Preferably, the main catalyst is a magnesium chloride-supported titanium tetrachloride catalyst, the co-catalyst is an alkylaluminum, and the external electron donor is an alkoxysilane.

Preferably, the pre-polymerizing is performed at a temperature of 15° C. to 25° C. for a residence time of 10 min to 20 min.

Preferably, in the step B), the polymerization reaction is performed at a temperature of 70° C. to 75° C. for a residence time of 30 min to 50 min; a total flow rate of ethylene and propylene is 20 t/h to 40 t/h, a mass ratio of ethylene to propylene is (2-5):(98-95), and a concentration of hydrogen is 2000 ppm to 3000 ppm.

Preferably, in the step C), the polymerization reaction is performed at a temperature of 70° C. to 75° C. for a residence time of 10 min to 30 min; a total flow rate of ethylene and propylene is 10 t/h to 20 t/h, a mass ratio of ethylene to propylene is (2-5):(98-95), and a concentration of hydrogen is 2000 ppm to 3000 ppm.

Preferably, based on parts by weight, in the step D), 100 parts of the polypropylene resin powder, 0.15 parts to 0.35 parts of the sorbitol-based nucleating agent, 0.1 parts to 0.3 parts of the antioxidant, 0.01 parts to 0.2 parts of the halogen scavenger, and 0.01 parts to 0.1 parts of the antistatic agent are used.

Preferably, the antioxidant comprises a primary antioxidant and a secondary antioxidant;
a mass ratio of the primary antioxidant to the secondary antioxidant is 1:(1-4);
the primary antioxidantis is selected from the group consisting of antioxidant 2246 (2,2′-methylenebis(4-methyl-6-tert-butylphenol, CAS: 119-47-1), antioxidant 1010 (pentaerythritol tetrakis [β-(3,5-di-tert-butyl-4-hydroxyphenyl) propionate, CAS: 6683-19-8), antioxidant 1076 (octadecyl β-(3,5-di-tert-butyl-4-hydroxyphenyl) propionate, CAS: 2082-79-3), antioxidant 1330 (1,3,5-trimethyl-2,4,6-tris(3,5-di-tert-butyl-4-hydroxybenzyl)benzene, CAS: 1709-70-2), and a combination thereof, and the secondary antioxidant is selected from the group consisting of antioxidant 168 (tris(2,4-di-tert-butylphenyl) phosphite, CAS: 31570 Apr. 4), antioxidant 626 (bis(2,4-di-tert-butylphenyl) pentaerythritol diphosphite, CAS: 26741-53-7), and a combination thereof.

Preferably, the halogen scavenger is selected from the group consisting of sodium stearate, calcium stearate, zinc stearate, and a combination thereof; and
the antistatic agent is selected from the group consisting of glycerol monostearate, polyol fatty acid ester, polyethylene oxide, propylene oxide copolymer, and a combination thereof.

The present disclosure further provides a transparent polypropylene resin prepared by the preparation method described above.

Preferably, the transparent polypropylene resin has a melt mass flow rate of 22 g/10 min to 30 g/10 min, an ethylene content of 3.0 wt % to 3.5 wt %, and a haze of 5% to 10%.

The present disclosure provides a method for preparing a transparent polypropylene resin, comprising steps of: A) pre-polymerizing propylene in the presence of a main catalyst, a polymeric nucleating agent, a co-catalyst, and an external electron donor; wherein the polymeric nucleating agent is selected from the group consisting of poly(vinylcyclopentane), poly(vinylcyclohexane), poly(vinyl-2-methylcyclohexane), poly(3-methyl-1-butene), poly(3-ethyl-1-hexene), poly(3-methyl-1-pentene), polystyrene, and a combination thereof, and a mass ratio of the main catalyst to the polymeric nucleating agent is 1:(1-2); B) subjecting the pre-polymerization product, propylene, ethylene, and hydrogen to a polymerization reaction to obtain a polypropylene powder; C) continuing a polymerization reaction of the polypropylene powder, propylene, ethylene, and hydrogen to obtain a polypropylene resin powder; D) mixing the polypropylene resin powder, an antioxidant, a halogen scavenger, an antistatic agent, and a sorbitol-based nucleating agent evenly to obtain a mixture; wherein the sorbitol-based nucleating agent is selected from the group consisting of 1,3:2,4-dibenzylidene sorbitol, 1,3:2,4-di(4-methylbenzylidene) sorbitol, 1,3:2,4-di(4-ethylbenzylidene) sorbitol, 1,3:2,4-bis(3,4-dimethylbenzylidene) sorbitol, and a combination thereof; and a mass ratio of the polymeric nucleating agent to the sorbitol-based nucleating agent is 1:(75-150); and E) extruding the mixture through an extruder to obtain a transparent polypropylene material; wherein a temperature of the highest temperature zone of the extruder is 230° C. to 240° C.

Compared with the prior art, the technical solution of the present disclosure has the following beneficial effects:

\textcircled{1} Significant cost-effectiveness: Preparing transparent polypropylene by using fourth-generation transparent nucleating agents has high cost, while preparing transparent polypropylene by using third-generation transparent nucleating agents has low cost but higher haze than that of polypropylene prepared using fourth-generation nucleating agents. In the composition of the transparent polypropylene resin of the present disclosure, the replacement of the fourth-generation nucleating agent with the third-generation nucleating agent is achieved, and the obtained transparency is comparable to that of the fourth-generation nucleating agent NX 8000. This greatly reduces the preparation cost of transparent polypropylene and improves the market competitiveness of the product.

\textcircled{2} Significant improvement in transparency: In the composition of the transparent polypropylene resin of the present disclosure, a specific ratio of a polymeric nucleating agent and a sorbitol-based nucleating agent (3988) is used. The synergistic effect of these two nucleating agents can significantly improve the transparency of polypropylene. Even at a low nucleating agent addition amount (3988 addition amount of 1500 ppm), a significant transparency effect can be obtained; it also increases the upper limit of transparency enhancement of the third-generation transparent nucleating agent (increasing the upper limit of the effect of the 3988 nucleating agent at an addition amount of 3000 ppm and above from a haze value of 8-10% to 5-6%).

\textcircled{3} Improvement in mechanical properties: While improving the transparency of the polypropylene product, the mechanical properties are also improved. The rigidity and toughness are increased by about 10% and the heat resistance is improved.

### DETAILED DESCRIPTION

The present disclosure provides a method for preparing a transparent polypropylene resin, which comprises steps of:
A) pre-polymerizing propylene in the presence of a main catalyst, a polymeric nucleating agent, a co-catalyst, and an external electron donor;
wherein the polymeric nucleating agent is selected from the group consisting of poly(vinylcyclopentane), poly(vinylcyclohexane), poly(vinyl-2-methylcyclohexane), poly(3-methyl-1-butene), poly(3-ethyl-1-hexene), poly(3-methyl-1-pentene), polystyrene, and a combination thereof; and a mass ratio of the main catalyst to the polymeric nucleating agent is 1:(1-2);
B) subjecting the pre-polymerization product, propylene, ethylene, and hydrogen to a polymerization reaction to obtain a polypropylene powder;
C) continuing a polymerization reaction of the polypropylene powder, propylene, ethylene, and hydrogen to obtain a polypropylene resin powder;
D) mixing the polypropylene resin powder, an antioxidant, a halogen scavenger, an antistatic agent, and a sorbitol-based nucleating agent evenly to obtain a mixture;
wherein the sorbitol-based nucleating agent is selected from the group consisting of 1,3:2,4-dibenzylidene sorbitol, 1,3:2,4-di(4-methylbenzylidene) sorbitol, 1,3:2,4-di(4-ethylbenzylidene) sorbitol, 1,3:2,4-bis(3,4-dimethylbenzylidene) sorbitol, and a combination thereof; and a mass ratio of the polymeric nucleating agent to the sorbitol-based nucleating agent is 1:(75-150); and
E) extruding the mixture through an extruder to obtain a transparent polypropylene material;
wherein a temperature of the highest temperature zone of the extruder is 230° C. to 240° C.

In the present disclosure, a spheripol polymerization process is performed by using propylene as the raw material, a magnesium chloride-supported titanium tetrachloride catalyst as the main catalyst, an alkylaluminum as the co-catalyst, an alkoxysilane as the external electron donor and adding a polymeric nucleating agent; hydrogen is used as a molecular weight regulator and ethylene is added into the reactor to obtain the polypropylene resin powder. Then, the polypropylene resin powder, a primary antioxidant, a secondary antioxidant, a halogen scavenger, and a sorbitol-based nucleating agent are mixed evenly and extruded through an extruder to prepare a transparent polypropylene material with a melt mass flow rate of 22 g/10 min to 30 g/10 min and an ethylene content of 3.0 wt % to 3.5 wt %.

In the present disclosure, the main catalyst is a magnesium chloride-supported titanium tetrachloride catalyst, the co-catalyst is an alkylaluminum, preferably triethylaluminum, and the external electron donor is an alkoxysilane, such as methylcyclohexyldimethoxysilane; the polymeric nucleating agent is preferably selected from the group consisting of poly(vinylcyclopentane), poly(vinylcyclohexane), poly(vinyl-2-methylcyclohexane), poly(3-methyl-1-butene), poly(3-ethyl-1-hexene), poly(3-methyl-1-pentene), polystyrene, and combination thereof; a mass ratio of the main catalyst to the polymeric nucleating agent is preferably 1:(1-2), more preferably 1:(1.2-1.8), such as 1:1, 1:1.1, 1:1.2, 1:1.3, 1:1.4, 1:1.5, 1:1.6, 1:1.7, 1:1.8, 1:1.9, 1:2, and preferably a range value with any of the above-mentioned values as the upper or lower limit.

In the present disclosure, the continuous pre-contact and pre-polymerization are firstly used to ensure the stability of polymer quality and prevent equipment fluctuations.

In the present disclosure, the flow rate of the propylene is preferably 2 t/h to 2.8 t/h, more preferably 2.2 t/h to 2.6 t/h, such as 2 t/h, 2.1 t/h, 2.2 t/h, 2.3 t/h, 2.4 t/h, 2.5 t/h, 2.6 t/h, 2.7 t/h, 2.8 t/h, and preferably a range value with any of the above-mentioned values as the upper or lower limit; a mass ratio of the co-catalyst to propylene is preferably 0.1 g/kg to 0.15 g/kg, such as 0.1 g/kg, 0.2 g/kg, 0.3 g/kg, 0.4 g/kg, 0.5 g/kg, and preferably a range value with any of the above values as the upper or lower limit; a mass ratio of the co-catalyst to the external electron donor is preferably (3-5): 1, and more preferably 4:1; a mass ratio of the main catalyst to the co-catalyst is preferably 1:(10-20), more preferably 1:(12-18), such as 1:10, 1:11, 1:12, 1:13, 1:14, 1:15, 1:16, 1:17, 1:18, 1:19, 1:20, and preferably a range value with any of the above-mentioned values as the upper or lower limit; in the present disclosure, the pre-polymerization is preferably performed at a temperature of 15° C. to 25° C., more preferably 20° C., the pre-polymerization is preferably performed for a residence time of 10 min to 20 min, and more preferably 15 min.

In the present disclosure, after the pre-polymerization is completed, the pre-polymerization product, propylene, ethylene, and hydrogen are introduced into a first reactor to perform a polymerization reaction to obtain a polypropylene powder.

In the present disclosure, the polymerization reaction is preferably performed at a temperature of 70° C. to 75° C., such as 70° C., 71° C., 72° C., 73° C., 74° C., 75° C., and preferably a range value with any of the above-mentioned values as the upper or lower limit; the polymerization reaction is preferably performed for a residence time of 30 min to 50 min, more preferably 35 min to 45 min, such as 30 min, 35 min, 40 min, 45 min, 50 min, and preferably a range value with any of the above-mentioned values as the upper or lower limit.

In the present disclosure, the total flow rate of ethylene and propylene in the first reactor is preferably 20 t/h to 40 t/h, more preferably 25 t/h to 35 t/h, such as 20 t/h, 25 t/h, 30 t/h, 35 t/h, 40 t/h, and preferably a range value with any of the above-mentioned values as the upper or lower limit; wherein, a mass ratio of ethylene to propylene is preferably (2-5):(98-95), more preferably (3-4):(97-96), such as 2:98, 3:97, 3.5:96.5, 4:96, 5:95, and preferably a range value with any of the above-mentioned values as the upper or lower limit; a hydrogen concentration in the first reactor is controlled to be 2000 ppm to 3000 ppm, such as 2000 ppm, 2100 ppm, 2200 ppm, 2300 ppm, 2400 ppm, 2500 ppm, 2600 ppm, 2700 ppm, 2800 ppm, 2900 ppm, 3000 ppm, and preferably a range value with any of the above-mentioned values as the upper or lower limit.

In the present disclosure, the first reactor is preferably a first loop reactor.

In the present disclosure, after the above-mentioned polymerization reaction is completed, the obtained polypropylene powder, propylene, ethylene, and hydrogen are introduced into a second reactor to continue a polymerization reaction to obtain a polypropylene resin powder. New materials enter the first reactor for reaction, thereby realizing such a continuous cycle.

In the present disclosure, the polymerization reaction is preferably performed at a temperature of 70° C. to 75° C., such as 70° C., 71° C., 72° C., 73° C., 74° C., 75° C., and preferably a range value with any of the above-mentioned values as the upper or lower limit; the polymerization reaction is preferably performed for a residence time of 10 min to 30 min, more preferably 15 min to 25 min, such as 10 min, 15 min, 20 min, 25 min, 30 min, and preferably a range value with any of the above-mentioned values as the upper or lower limit.

In the present disclosure, the total flow rate of ethylene and propylene in the second reactor is preferably 10 t/h to 20 t/h, more preferably 12 t/h to 18 t/h, such as 10 t/h, 11 t/h, 12 t/h, 13 t/h, 14 t/h, 15 t/h, 16 t/h, 17 t/h, 18 t/h, 19 t/h, 20 t/h, and preferably a range value with any of the above-mentioned values as the upper or lower limit; wherein, a mass ratio of ethylene to propylene is preferably (2-5):(98-95), more preferably (3-4):(97-96), such as 2:98, 3:97, 3.6:96.4, 4:96, 5:95, and preferably a range value with any of the above-mentioned values as the upper or lower limit; a hydrogen concentration in the first reactor is controlled to be 2000 ppm to 3000 ppm, such as 2000 ppm, 2100 ppm, 2200 ppm, 2300 ppm, 2400 ppm, 2500 ppm, 2600 ppm, 2700 ppm, 2800 ppm, 2900 ppm, 3000 ppm, and preferably a range value with any of the above-mentioned values as the upper or lower limit.

In the present disclosure, the second reactor is preferably a second loop reactor.

In the present disclosure, after the polypropylene resin powder is obtained, the polypropylene resin powder, an antioxidant, a halogen scavenger, an antistatic agent, and a sorbitol-based nucleating agent were mixed evenly to obtain a mixture.

In the present disclosure, the polypropylene resin powder is an ethylene-propylene random copolymer polypropylene resin. Based on parts by weight, the amount of the polypropylene resin powder is preferably 100 parts.

In the present disclosure, the antioxidant preferably comprises a primary antioxidant and a secondary antioxidant; a mass ratio of the primary antioxidant to the secondary antioxidant is 1:(1-4), and preferably 1:(2-3); the primary antioxidant is selected from the group consisting of antioxidant 2246, antioxidant 1010, antioxidant 1076, antioxidant 1330, and combination thereof; the secondary antioxidant is selected from the group consisting of antioxidant 168, antioxidant 626, and combination thereof; an amount of the antioxidant is preferably 0.1 parts by weight to 0.3 parts by weight, more preferably 0.15 parts by weight to 0.25 parts by weight, such as 0.1 part, 0.15 parts, 0.2 parts, 0.25 parts, 0.3 parts, and preferably a range value with any of the above-mentioned values as the upper or lower limit.

In the present disclosure, the halogen scavenger is preferably selected from the group consisting of sodium stearate, calcium stearate, zinc stearate, and combination thereof; an amount of the halogen scavenger is preferably 0.01 parts by weight to 0.2 parts by weight, more preferably 0.1 parts by weight to 0.15 parts by weight, such as 0.01 part, 0.05 parts, 0.1 parts, 0.15 parts, 0.2 parts, and preferably a range value with any of the above-mentioned values as the upper or lower limit.

In the present disclosure, the antistatic agent is preferably selected from the group consisting of glycerol monostearate, polyol fatty acid ester, polyethylene oxide, propylene oxide copolymer, and combination thereof, an amount of the antistatic agent is preferably 0.01 parts by weight to 0.1 parts by weight, such as 0.01 part, 0.02 parts, 0.03 parts, 0.04 parts, 0.05 parts, 0.06 parts, 0.07 parts, 0.08 parts, 0.09 parts, 0.1 part, preferably a range value with any of the above-mentioned values as the upper or lower limit.

In the present disclosure, the sorbitol-based nucleating agent is preferably selected from the group consisting of 1,3:2,4-dibenzylidene sorbitol, 1,3:2,4-di(4-methylbenzylidene) sorbitol, 1,3:2,4-di(4-ethylbenzylidene) sorbitol, 1,3:2,4-bis(3,4-dimethylbenzylidene) sorbitol, and combination thereof, and more preferably 1,3:2,4-bis(3,4-dimethylbenzylidene) sorbitol (i.e., the third-generation nucleating agent 3988); an amount of the sorbitol-based nucleating agent is preferably 0.15 parts by weight to 0.35 parts by weight, more preferably 0.15 parts by weight to 0.2 parts by weight, such as 0.15 parts, 0.16 parts, 0.17 parts, 0.18 parts, 0.19 parts, 0.2 parts, 0.21 parts, 0.22 parts, 0.23 parts, 0.24 parts, 0.25 parts, 0.26 parts, 0.27 parts, 0.28 parts, 0.29 parts, 0.3 parts, 0.31 parts, 0.32 parts, 0.33 parts, 0.34 parts, 0.35 parts, and preferably a range value with any of the above-mentioned values as the upper or lower limit.

In the present disclosure, the combined use of the polymeric nucleating agent and the sorbitol-based nucleating agent improves the transparency of the polypropylene products while also improving their mechanical properties. A mass ratio of the polymeric nucleating agent to the sorbitol-based nucleating agent is preferably 1:(75-150), more preferably 1:(100-125), such as 1:75, 1:80, 1:85, 1:90, 1:95, 1:100, 1:105, 1:110, 1:115, 1:120, 1:125, 1:130, 1:135, 1:140, 1:145, 1:150, and preferably a range value with any of the above-mentioned values as the upper or lower limit. That is, based on 100 parts by weight of the polypropylene resin powder, the amount of the polymeric nucleating agent is preferably 0.002 parts by weight to 0.005 parts by weight, more preferably 0.002 parts by weight to 0.004 parts by weight, such as 0.002 parts, 0.003 parts, 0.004 parts, 0.005 parts, and preferably a range value with any of the above-mentioned values as the upper or lower limit.

In the present disclosure, the mixing is preferably performed by a conventional mixing method. In the present disclosure, the polypropylene resin powder, antioxidant, halogen scavenger, antistatic agent, and sorbitol-based nucleating agent are preferably added into an extruder and blended in the extruder to obtain a mixture.

In the present disclosure, after the mixture is obtained, the mixture is extruded through an extruder to obtain the transparent polypropylene resin.

In the present disclosure, a temperature of the highest temperature zone of the extruder is preferably 230° C. to 240° C., such as 230° C., 231° C., 232° C., 233° C., 234° C., 235° C., 236° C., 237° C., 238° C., 239° C., 240° C., and preferably a range value with any of the above-mentioned values as the upper or lower limit. The extruder in the present disclosure is provided with multiple temperature zones, with the overall temperature trend being lower temperatures in the two end temperature zones and higher temperatures in the middle temperature zones. In the present disclosure, it should be ensured that the temperature of at least one middle temperature zone can exceed 230° C. Alternatively, 2 to 3 middle temperature zones can be provided with temperatures >230° C. When only one temperature zone has a temperature exceeding 230° C., the temperature zone is the temperature zone with the highest temperature among all temperature zones. Specifically, in the embodiments of the present disclosure, the extruder can be configured with nine temperature zones: zone 1:175° C. to 185° C., zone 2:185° C. to 195° C., zone 3:205° C. to 215° C., zone 4:225° C. to 235° C., zone 5:230° C. to 240° C., zone 6:225° C. to 235° C., zone 7:205° C. to 215° C., zone 8:195° C. to 205° C., and zone 9:185° C. to 195° C.; more preferably, zone 1:180° C., zone 2:190° C., zone 3:210° C., zone 4:230° C., zone 5:235° C., zone 6:230° C., zone 7:210° C., zone 8:200° C., and zone 9:190° C. In this temperature zone configuration, the highest temperature zone is zone 5, and three temperature zones (zone 4, zone 5, and zone 6) have temperatures ≥230° C.

The present disclosure provides a transparent polypropylene resin prepared by the preparation method described above.

In the present disclosure, the transparent polypropylene resin has a melt mass flow rate of 22 g/10 min to 30 g/10 min, an ethylene content of 3.0 wt % to 3.5 wt %, a haze of 5% to 10%; and a crystallization temperature >116° C.

The present disclosure provides a method for preparing a transparent polypropylene resin, which comprises steps of: A) pre-polymerizing propylene in the presence of a main catalyst, a polymeric nucleating agent, a co-catalyst, and an external electron donor; wherein the polymeric nucleating agent is selected from the group consisting of poly(vinylcyclopentane), poly(vinylcyclohexane), poly(vinyl-2-methylcyclohexane), poly(3-methyl-1-butene), poly(3-ethyl-1-hexene), poly(3-methyl-1-pentene), polystyrene, and a combination thereof, and a mass ratio of the main catalyst to the polymeric nucleating agent is 1:(1-2); B) subjecting the pre-polymerization product, propylene, ethylene, and hydrogen to a polymerization reaction to obtain a polypropylene powder; C) continuing a polymerization reaction of the polypropylene powder, propylene, ethylene, and hydrogen to obtain a polypropylene resin powder; D) mixing the polypropylene resin powder, an antioxidant, a halogen scavenger, an antistatic agent, and a sorbitol-based nucleating agent evenly to obtain a mixture; wherein the sorbitol-based nucleating agent is selected from the group consisting of 1,3:2,4-dibenzylidene sorbitol, 1,3:2,4-di(4-methylbenzylidene) sorbitol, 1,3:2,4-di(4-ethylbenzylidene) sorbitol, 1,3:2,4-bis(3,4-dimethylbenzylidene) sorbitol, and a combination thereof; and a mass ratio of the polymeric nucleating agent to the sorbitol-based nucleating agent is 1:(75-150); and E) extruding the mixture through an extruder to obtain a transparent polypropylene material; wherein a extruding temperature of the extruder is 230° C. to 240° C.

Compared with the prior art, the beneficial effects of the present technical solution are as follows:

\textcircled{1} Significant cost-effectiveness: Preparing transparent polypropylene by using fourth-generation transparent nucleating agents has high cost, while preparing transparent polypropylene by using third-generation transparent nucleating agents has low cost but higher haze than that of polypropylene prepared using fourth-generation nucleating agents. In the composition of the transparent polypropylene resin of the present disclosure, the replacement of the fourth-generation nucleating agent with the third-generation nucleating agent is achieved, and the obtained transparency is comparable to that of the fourth-generation nucleating agent NX 8000. This greatly reduces the preparation cost of transparent polypropylene and improves the market competitiveness of the product.

\textcircled{2} Significant improvement in transparency: In the composition of the transparent polypropylene resin of the present disclosure, a specific ratio of a polymeric nucleating agent and a sorbitol-based nucleating agent (3988) is used. The synergistic effect of these two nucleating agents can significantly improve the transparency of polypropylene. Even at a low nucleating agent addition amount (3988 addition amount of 1500 ppm), a significant transparency effect can be obtained; it also increases the upper limit of transparency enhancement of the third-generation transparent nucleating agent (increasing the upper limit of the effect of the 3988 nucleating agent at an addition amount of 3000 ppm and above from a haze value of 8-10% to 5-6%).

\textcircled{3} Improvement in mechanical properties: While improving the transparency of the polypropylene product, the mechanical properties are also improved. The rigidity and toughness are increased by about 10% and the heat resistance is improved.

To further illustrate the present disclosure, a transparent polypropylene resin and a preparation method thereof provided by the present disclosure is described in detail below in conjunction with examples, but it should not be construed as limitation to the protection scope of the present disclosure.

### Example 1

(1) Propylene was pre-polymerized under the combined action of an HR catalyst, poly(vinylcyclohexane), triethylaluminum, and methylcyclohexyldimethoxysilane by using the spheripol polymerization process, wherein a mass ratio of the HR catalyst to poly(vinylcyclohexane) was 1:1.2, a mass ratio of the HR catalyst to the co-catalyst was 1:15, a ratio of the co-catalyst to propylene was 0.125 g/kg, a mass ratio of the co-catalyst to the external electron donor was 4, and the pre-polymerization was performed at a temperature of 20° C. for a residence time of 15 min;

(2) The pre-polymerization product obtained from step (1), propylene, and hydrogen were fed into a first loop reactor to conduct polymerization to obtain a polypropylene powder, wherein the hydrogen concentration in the first loop reactor was controlled at 2000 ppm, a total flow rate of ethylene and propylene was 30 t/h, a mass flow ratio of ethylene to propylene was 3.5:96.5, and the reaction was performed at a temperature of 72° C. for a residence time of 40 min;

(3) The polypropylene powder obtained from step (2), propylene, ethylene, and hydrogen were fed into a second loop reactor to continue a polymerization reaction to obtain a polypropylene resin powder, wherein the hydrogen concentration in the second loop reactor was controlled at 2000 ppm, a total flow rate of ethylene and propylene was 15 t/h, a mass flow ratio of ethylene to propylene was 3.6:96.4, and the reaction was performed at a temperature of 72° C. for a residence time of 20 min;

(4) The polypropylene resin powder obtained from step (3), an antioxidant, a halogen scavenger, an antistatic agent, and a nucleating agent were mixed evenly to obtain a mixture. The formulation is shown in Table 1, wherein the amount of the 3988 nucleating agent (1,3:2,4-bis(3,4-dimethylbenzylidene) sorbitol) was 0.15 parts;

(5) The mixture obtained from step (4) was extruded through an extruder, and the maximum temperature of the barrel of the extruder was controlled at 235° C. to prepare a polypropylene resin. Its performance test results and test methods are shown in Table 2.

### Example 2

The preparation method was the same as in Example 1, except that the amount of the 3988 nucleating agent was 0.2 parts.

Its performance test results and test methods are shown in Table 2.

### Example 3

The preparation method was the same as in Example 1, except that the amount of the 3988 nucleating agent was 0.3 parts.

Its performance test results and test methods are shown in Table 2.

### Comparative Example 1

The preparation method was the same as in Example 2, except that the polymeric nucleating agent poly(vinylcyclohexane) (PVCH) was not added in the pre-polymerization stage, and the amount of the 3988 nucleating agent (1,3:2,4-bis(3,4-dimethylbenzylidene) sorbitol) was 0.202 parts.

Its performance test results and test methods are shown in Table 2.

### Comparative Example 2

The preparation method was the same as in Example 3, except that the polymeric nucleating agent poly(vinylcyclohexane) (PVCH) was not added in the pre-polymerization stage, and the amount of the 3988 nucleating agent was 0.302 parts.

### Comparative Example 3

The preparation method was the same as in Comparative Example 1, except that 0.202 parts of the NX8000 nucleating agent was used instead of the 0.202 parts of the 3988 nucleating agent in Comparative Example 1.

### Comparative Example 4

The preparation method was the same as in Comparative Example 1, except that 0.302 parts of the NX8000 nucleating agent was used instead of the 0.202 parts of the 3988 nucleating agent in Comparative Example 1.

### Comparative Example 5

The preparation method was the same as in Example 2, except that the maximum temperature of the barrel of the extruder was controlled at 220° C.

### Comparative Example 6

The preparation method was the same as in Example 2, except that 0.2 parts of the NX8000 nucleating agent was used instead of the 0.2 parts of the 3988 nucleating agent in Example 2.

### Comparative Example 7

The preparation method was the same as in Example 2, except that the 3988 nucleating agent was not added, and a mass ratio of the HR catalyst to the poly(vinylcyclohexane) was 1:121.2, and the final product had a PVCH content of 2020 ppm.

### Comparative Example 8

The preparation method was the same as in Example 2, except that the polymeric nucleating agent PVCH was added during the pelletizing stage, and in the pelletizing stage, the amount of the 3988 nucleating agent was 0.2 parts, and an additional 0.002 parts of PVCH was added.

TABLE 1
Component ratios and processing conditions for Examples and Comparative Examples

| | | | | | Compar- | Compar- | Compar- | Compar- | Compar- | Compar- | Compar- | Compar- |
|---|---|---|---|---|---|---|---|---|---|---|---|---|
| | | Exam- | Exam- | Exam- | ative | ative | ative | ative | ative | ative | ative | ative |
| | | mple | mple | mple | Exam- | Exam- | Exam- | Exam- | Exam- | Exam- | Exam- | Exam- |
| Components | | 1 | 2 | 3 | ple 1 | ple 2 | ple 3 | ple 4 | ple 5 | ple 6 | ple 7 | ple 8 |
| Homopolymer | /parts | 100 | 100 | 100 | 100 | 100 | 100 | 100 | 100 | 100 | 100 | 100 |
| polypropylene | PVCH | 20 | 20 | 20 | 0 | 0 | 0 | 0 | 20 | 20 | 2020 | 0 |
| | content/ | | | | | | | | | | | |
| | ppm | | | | | | | | | | | |

| | | | | | | | | | | | |
|---|---|---|---|---|---|---|---|---|---|---|---|
| Antioxidant | 0.05 | 0.05 | 0.05 | 0.05 | 0.05 | 0.05 | 0.05 | 0.05 | 0.05 | 0.05 | 0.05 |
| 1010/parts | | | | | | | | | | | |
| Antioxidant | 0.1 | 0.1 | 0.1 | 0.1 | 0.1 | 0.1 | 0.1 | 0.1 | 0.1 | 0.1 | 0.1 |
| 168/parts | | | | | | | | | | | |
| Calcium | 0.05 | 0.05 | 0.05 | 0.05 | 0.05 | 0.05 | 0.05 | 0.05 | 0.05 | 0.05 | 0.05 |
| stearate/parts | | | | | | | | | | | |
| GMS90/parts | 0.05 | 0.05 | 0.05 | 0.05 | 0.05 | 0.05 | 0.05 | 0.05 | 0.05 | 0.05 | 0.05 |
| 3988/parts | 0.15 | 0.2 | 0.3 | 0.202 | 0.302 | 0 | 0 | 0.2 | 0 | 0 | 0.2 |
| NX8000/parts | 0 | 0 | 0 | 0 | 0 | 0.202 | 0.302 | 0 | 0.2 | 0 | 0 |
| (Granulation) | 0 | 0 | 0 | 0 | 0 | 0 | 0 | 0 | 0 | 0 | 0.002 |
| PVCH/parts | | | | | | | | | | | |
| Maximum | 235 | 235 | 235 | 235 | 235 | 235 | 235 | 220 | 235 | 235 | 235 |
| granulation | | | | | | | | | | | |
| temperature/° C. | | | | | | | | | | | |

The performance of the transparent polypropylene resins obtained in Examples 1 to 3 and Comparative Examples 1 to 8 was tested, and the results are shown in Table 2.

TABLE 2
Performance parameters of transparent polypropylene resin in Examples and Comparative Examples

| | | | | Compar- | Compar- | Compar- | Compar- | Compar- | Compar- | Compar- | Compar- |
|---|---|---|---|---|---|---|---|---|---|---|---|
| | | | | ative | ative | ative | ative | ative | ative | ative | ative |
| | Exam- | Exam- | Exam- | Exam- | Exam- | Exam- | Exam- | Exam- | Exam- | Exam- | Exam- |
| Test items | ple 1 | ple 2 | ple 3 | ple 1 | ple 2 | ple 3 | ple 4 | ple 5 | ple 6 | ple 7 | ple 8 |
| Melt flow rate | 27.0 | 27.5 | 27.8 | 26.6 | 26.9 | 27.0 | 27.2 | 27.3 | 27.2 | 27.1 | 27.5 |
| (g/10 min) | | | | | | | | | | | |
| Ethylene | 3.1 | 3.1 | 3.2 | 3.1 | 3.2 | 3.2 | 3.1 | 3.2 | 3.1 | 3.3 | 3.2 |
| content/wt % | | | | | | | | | | | |
| Crystallization | 116.1 | 116.3 | 116.5 | 115.2 | 115.5 | 115.6 | 115.9 | 115.0 | 115.0 | 115.8 | 115.2 |
| temperature/° C. | | | | | | | | | | | |
| Notched Izod | 6.3 | 6.2 | 6.1 | 4.7 | 4.9 | 4.7 | 5.0 | 4.5 | 4.5 | 5.1 | 4.5 |
| impact strength | | | | | | | | | | | |
| of simply | | | | | | | | | | | |
| supported beam | | | | | | | | | | | |
| (23° C./kJ/m³) | | | | | | | | | | | |
| Flexural | 1120 | 1125 | 1165 | 1050 | 1077 | 1055 | 1099 | 1020 | 998 | 1055 | 1022 |
| modulus/MPa | | | | | | | | | | | |
| Heat distortion | 82 | 83 | 83 | 78 | 79 | 80 | 80 | 78 | 77 | 79 | 77 |
| temperature/° C. | | | | | | | | | | | |
| Haze/% | 9.1 | 7.2 | 5.1 | 10.7 | 9.1 | 10.1 | 6.8 | 11.9 | 11.9 | 30 | 10.9 |

### Performance Comparison Analysis:

By comparing Examples 1 to 3 with Comparative Examples 1 to 2 and Comparative Example 7, it can be seen that the combined use of the polymeric nucleating agent and 3988 can effectively improve the transparency of the PPR (with reduced haze); simultaneously, it can effectively improve its rigidity, toughness, and heat resistance. Specifically, comparing Example 2 with Comparative Example 1 and Comparative Example 7, the total amount of nucleating agent is the same (2020 ppm). However, the polypropylene material obtained in Comparative Example 1 has a crystallization temperature below 116° C., significantly reduced mechanical properties, and a haze of 10.7, which is higher than the 7.2 of Example 2. The polypropylene material in Comparative Example 7 also has a crystallization temperature below 116° C., significantly reduced mechanical properties, and a haze as high as 30, which is significantly higher than that of Example 2. This demonstrates that the present disclosure achieves superior technical effects by combined use of polymeric nucleating agent with a specific type of sorbitol-based nucleating agent, leading to significant improvements in both mechanical properties and haze performance. Similarly, the same conclusion is drawn from the comparison between Example 3 and Comparative Example 2.

By comparing Example 2 with Comparative Example 3, and comparing Example 3 with Comparative Example 4, it can be seen that the combined use of the polymeric nucleating agent and 3988 provides better transparency enhancement than NX8000; simultaneously, it exhibits superior rigidity, toughness, and heat resistance.

By comparing Example 2 with Comparative Example 5, it can be seen that controlling the maximum temperature of the barrel of the extruder at 235° C. is an important condition; failure to meet this temperature requirement directly affects product performance.

By comparing Example 2 with Comparative Examples 3 and 6, it can be seen that the combined use of the polymeric nucleating agent and 3988 has a synergistic effect. In contrast, when combined with NX8000, not only is there no synergy effect, but the optical properties of the product are affected.

By comparing Comparative Example 8 with Example 2, it can be seen that PVCH must be added during the polymerization stage to achieve the desired effect.

The above descriptions are only preferred embodiments of the present disclosure. It should be noted that, for those skilled in the art, several improvements and modifications may be further made without departing from the principle of the present disclosure, and these improvements and modifications should also be deemed as falling into the protection scope of the present disclosure.

1. A method for preparing a transparent polypropylene resin, comprising steps of:
A) pre-polymerizing propylene in the presence of a main catalyst, a polymeric nucleating agent, a co-catalyst, and an external electron donor;
wherein the polymeric nucleating agent is selected from the group consisting of poly(vinylcyclopentane), poly(vinylcyclohexane), poly(vinyl-2-methylcyclohexane), poly(3-methyl-1-butene), poly(3-ethyl-1-hexene), poly(3-methyl-1-pentene), polystyrene, and a combination thereof; and a mass ratio of the main catalyst to the polymeric nucleating agent is 1:(1-2);
B) subjecting the pre-polymerization product, propylene, ethylene, and hydrogen to a polymerization reaction to obtain a polypropylene powder;
C) continuing a polymerization reaction of the polypropylene powder, propylene, ethylene, and hydrogen to obtain a polypropylene resin powder;
D) mixing the polypropylene resin powder, an antioxidant, a halogen scavenger, an antistatic agent, and a sorbitol-based nucleating agent evenly to obtain a mixture;
wherein the sorbitol-based nucleating agent is 1,3:2,4-bis(3,4-dimethylbenzylidene) sorbitol; and a mass ratio of the polymeric nucleating agent to the sorbitol-based nucleating agent is 1:(75-150); and
E) extruding the mixture through an extruder to obtain a transparent polypropylene material;
wherein a temperature of the highest temperature zone of the extruder is 230° C. to 240° C.

2. The method according to claim 1, wherein the main catalyst is a magnesium chloride-supported titanium tetrachloride catalyst, the co-catalyst is an alkylaluminum, and the external electron donor is an alkoxysilane.

3. The method according to claim 1, wherein the pre-polymerizing is performed at a temperature of 15° C. to 25° C. for a residence time of 10 min to 20 min.

4. The method according to claim 1, wherein in the step B), the polymerization reaction is performed at a temperature of 70° C. to 75° C. for a residence time of 30 min to 50 min; a total flow rate of ethylene and propylene is 20 t/h to 40 t/h, a mass ratio of ethylene to propylene is (2-5):(98-95), and a concentration of hydrogen is 2000 ppm to 3000 ppm.

5. The method according to claim 1, wherein in the step C), the polymerization reaction is performed at a temperature of 70° C. to 75° C. for a residence time of 10 min to 30 min; a total flow rate of ethylene and propylene is 10 t/h to 20 t/h, a mass ratio of ethylene to propylene is (2-5):(98-95), and a concentration of hydrogen is 2000 ppm to 3000 ppm.

6. The method according to claim 1, wherein based on parts by weight, in the step D), 100 parts of the polypropylene resin powder, 0.15 parts to 0.35 parts of the sorbitol-based nucleating agent, 0.1 parts to 0.3 parts of the antioxidant, 0.01 parts to 0.2 parts of the halogen scavenger, and 0.01 parts to 0.1 parts of the antistatic agent are used.

7. (canceled)

8. The method according to claim 1, wherein the halogen scavenger is selected from the group consisting of sodium stearate, calcium stearate, zinc stearate, and a combination thereof; and
the antistatic agent is selected from the group consisting of glycerol monostearate, polyol fatty acid ester, polyethylene oxide, propylene oxide copolymer, and a combination thereof.

9. A transparent polypropylene resin, prepared by the method according to claim 1.

10. The transparent polypropylene resin according to claim 9, wherein the transparent polypropylene resin has a melt mass flow rate of 22 g/10 min to 30 g/10 min, an ethylene content of 3.0 wt % to 3.5 wt %, and a haze of 5% to 10%.
